(19) United States
(12) Patent Application Publication
(10) Pub. No.: US 2011/0025230 A1
(43) Pub. Date: Feb. 3, 2011

(54) DRIVER DEVICE FOR LEDS

(75) Inventors: Volkmar Schulz, Wuerselen (DE); Harald J.G. Radermacher, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,336

(22) PCT Filed: May 6, 2008
(86) PCT No.: PCT/IB2008/051748

§ 371 Date: Oct. 25, 2010

(30) Foreign Application Priority Data
May 11, 2007 (EP) 07108052.7

(51) Int. Cl. H05B 37/02

(52) U.S. Cl. 315/294

(57) ABSTRACT

The present invention relates to a driver device (10) for driving and controlling light emitting diodes (LEDs) or LED-strings comprising a control unit (16), and at least two switching units (14) coupled in series, and each comprising a switch (22) controllable by said control unit (16) and two connection points (30) for connecting at least one LED, wherein the first connection point (28) is coupled with one end of said switch (22). The driver device is characterized in that each switching unit (14.1 to 14.n) comprises an inductance coupled between the other end of said switch (22) and said second connection point (30).

### FIELD OF THE INVENTION

The present invention relates to a driver device for driving and controlling light emitting diodes (LEDs) or LED-strings/arrays comprising a control unit, an electroluminescent device comprising the driver device and LEDs or LED-strings/arrays connected to the driver device to emit mixed light and a method for operating the electroluminescent device in order to adjust brightness and/or color point of the emitted mixed light.

### BACKGROUND OF THE INVENTION

Driver devices for driving light emitting diodes are generally known, for example from document U.S. Pat. No. 6,153,980.

Generally, LEDs are currently in wide spread use in a variety of different signaling and lighting applications and LED-based luminary products. To increase the application field of LED-based luminaire products, LEDs with different colors (or CCT in case of white LEDs) can be used to generate light of a desired color. To achieve this, the average light output of the LEDs are set to a certain level so that the mixed light of all LEDs has the desired color.

To supply LEDs with power, so-called switch mode power supplies (SMPS) are widely used, since dissipative current limiting resistors result in pure efficiency. However, to generate different current for several LEDs producing different levels of light output it would be very expensive to use an SMPS for each LED. Another possibility to generate different currents for several LEDs is to connect the LED in a string and shunt (for a certain period of time) these LEDs which should have a lower light output compared to the others. A respective solution is for example disclosed in US 2006/0244396 A1. This results in a light output, which is also PWM-modulated (pulse-with-modulation).

Depending on the application (e.g. moving light sources like brake light in cars) or the sensing technique used to control the light output of the system, this modulated light output can produce problems like flickering or color breakup. In addition, the efficiency of LED is a function of the RMS-Current, resulting in lower efficiency when the LEDs are driven with a high current for a short period of time compare to the operation with a lower current for a longer period of time.

### SUMMARY OF THE INVENTION

In view of the above an object of the present invention is to provide a driver device for driving and controlling light emitting diodes or LED-strings which overcomes the deficiencies of prior art driver devices. Particularly, the driver device should have no flickering effects to the human eye and a smoothed sensed light output. The use for application should be improved with respect to high ambient temperatures or long life cycle requirements.

These and other objects are solved by a driver device as mentioned above, wherein each switching unit comprises an inductance coupled between the other end of said switch and said second connection point.

That is in other words that the driver device according to the present invention comprises at least two switching units, each comprising a switch controlled by the control unit and a series connection of an LED and an inductor, the series connection being parallel to the switch. Hence, each LED has its own inductor and switch. The inductor serves for smoothing the current; the switch serves for setting the average forward current of the LED. In doing so, the current of each LED can be controlled independently. Depending on the selection of the components and the selected time cycle, the driver device of the present invention can be used to produce the desired relation between average current and a ripple current. Driven in an appropriate way, the LED is driven with a DC-current with only little ripple, so that light output of the LED has also very low distortion. Flickering effects to the human eye can be avoided and, in case a sensor is used to measure the light output of an LED, the sensed signal can be smoothed. The circuit does not require capacitors, which eases the use for application with high ambient temperatures or long life cycle requirements. A further advantage of the inventive driver device is that instead of multiple current sources only a single voltage source with a series switch is required which is controlled via said control unit.

The inventive driver circuit can be used to drive LEDs, in example in general lighting, architectural lighting, or LCD backlight. It is especially suited for applications where the current flow of each LED in a string has to be varied and PWM-dimming is not suitable (where no PWM-based light output modulation is wanted).

In a preferred embodiment, a main switch coupled in series with said switching units and controllable by said control unit is provided. This measure has the advantage that the circuit may be switched on and off easily without the control of the switching units. In a further embodiment said control unit is adapted to control the main switch for adjusting the average current in said LED. Here, the total light output of all LEDs can be adjusted by only one switch.

In a preferred embodiment, said control unit is adapted to control said switches of said switching units such that only one switch is opened at the same time. It is further preferred that said control unit is adapted to control said switches individually to adjust the average current in said LED to adjust the light output of individual LEDs.

The invention further relates to an electroluminescent device comprising a driver device according to claim 1 and at least one LED connected to the first and second connection points of the driver device to emit mixed light. Mixed light denotes the superposed light of all LEDs.

In an embodiment of the electroluminescent device the inductance of the driver device is dimensioned such that an almost flicker-free driving of said LEDs is achievable. Here the required value of the inductance depends on the switching frequency f of the switch and the series resistance R_{LED} of the LEDs. Almost flicker-free driving is achieved with L>R_{LED}/f.

In another embodiment of the electroluminescent device, the LEDs of different switching units are able to provide light of different colors.

In a further embodiment of the electroluminescent device the control unit is adapted to control each switch individually for adjusting the color point of the mixed light.

The invention further relates to a method for operating an electroluminescent device according to claim 7 comprising the step
adjusting the individual average current of the LEDs or multiple LEDs connected to each switching unit via an adapted control unit in order to adjust the brightness of the emitted light of each LED or multiple LEDs.

In an embodiment the method further comprises the step
adjusting the individual average current of the LEDs connected to each switching unit emitting light of different colors in order to adjust the color point of the emitted mixed light of the electroluminescent device.

Further features and advantages can be taken from the following description and the enclosed drawing.

It should be noted that in the context of the present application “LED” also comprises organic LEDs (OLED) or any other type of light emitting diode and laser diodes. Multiple LEDs denote LEDs connected in series or in an array. It is to be understood that the features mentioned above and those yet to be explained below can be used not only in the respective combination indicated, but also in other combinations or in isolation, without leaving the scope of the present invention.

The invention will be explained in more detail in the drawings and in the description below.

### BRIEF DESCRIPTION OF THE DRAWINGS

In the drawings:

FIG. 1: a schematic block diagram of one example of an inventive electroluminescent device.

### DETAILED DESCRIPTION OF EMBODIMENTS

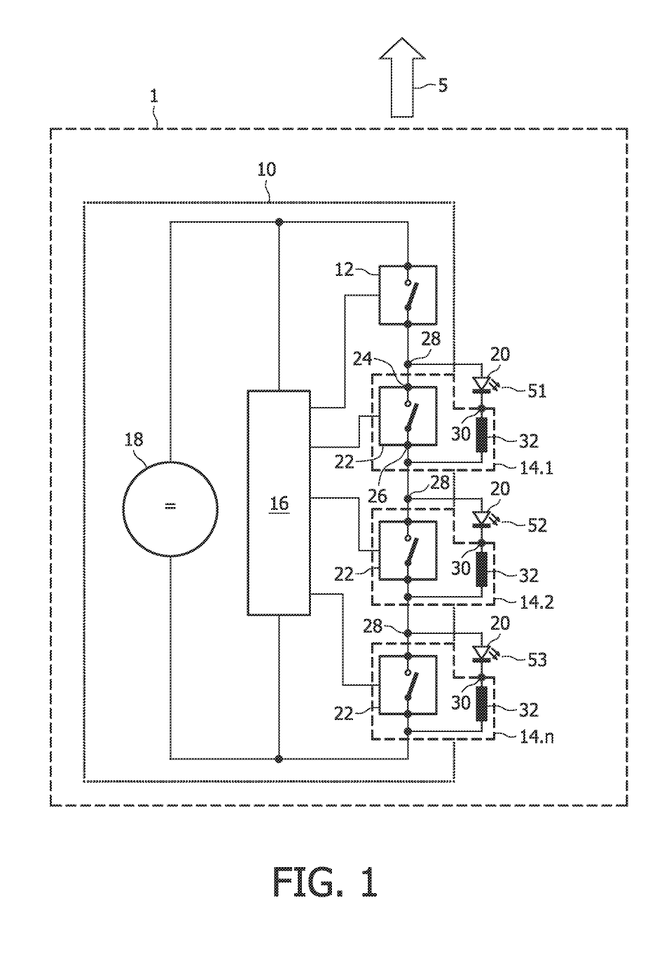

In FIG. 1, a driver device 10 for light emitting diodes is schematically shown and indicated with reference numeral 10. The driver device 10 comprises a main switch 12 and a plurality of switching units 14.1 to 14.n. The main switch 12 and the switching units 14 are connected in series and are coupled with a DC-power supply 18.

Further, the driver device 10 comprises a control unit 16 receiving power from the power supply 18 and being adapted to control the main switch 12 as well as the switching units 14. As an alternative, the control unit could receive power from a tap to some position in the Led string (not shown in FIG. 1).

The structure of each switching unit 14.1 to 14.n is similar so that only one switching unit 14.1 will be explained in more detail below.

The switching unit 14.1 comprises a switch 22, for example an electronic switch, like a transistor, or any other controllable switch, which has a first end 24 connected to the main switch 12 (or the preceding switching unit 14) and a second end 26 connected to the following switching unit 14.2. Depending on the type of electronic switch freewheeling elements may have to be used.

In FIG. 1, the main switch 12 and the switches 22 are illustrated as a mechanical switches. However, it is to be noted that also electronic switches, like transistors, etc., may be used.

As already mentioned before, the switch 22 is controlled by the control unit 16, which is illustrated by a control line between the control unit 16 and the switch 22.

The switching unit 14.1 comprises a first connection point 28 electrically connected to the first end 24 and a second connection point 30. Between both connection points 28, 30 a light emitting diode 20 (LED) may be connected. Here, it should be noted that the LED 20 represents one or more LEDs 20 connected in series and/or in parallel forming an LED-string or LED-array. For the sake of simplicity, only one LED is shown in FIG. 1.

Between the second connection point 30 and the second end 26 of the switch 22 an inductor 32 is connected. Hence, there is a series connection of the LED 20 and the inductor 32, which series connection is parallel to the switch 22. Hence, the switch 22 operates as a shunt or bypass-switch.

The driver device 10 operates as follows:

First, the main switch 12 has to be switched on so that the series connection of the switching units 14.1 to 14.n is coupled with the power supply 18.

When the switch 22 of a switching unit 14 is closed, the energy stored in the inductor 32 causes a current which is freewheeling through the closed switch and the LED 20. This current is decreasing due to power loss. When the switch is opened, an externally supply voltage is present at the serial connection of the LED 20 and the inductor 32. The current is increasing at a rate determined by the present voltage, the forward voltage of the LED 20 and the inductance of the inductor 32. By controlling the switch 22, namely the timing for turning it off and on, the average current through the LED 20 may be controlled.

The control of the average current through the LED 20 allows controlling its light output. The timing of the switch 22 is controlled by the control unit 16.

An electroluminescent device 1 for emitting mixed light 5 of a certain color and a certain brightness comprises the driver device 10 and LEDs 20 connected to the first and second connecting points 28 and 30 of each switching unit 14.1, 14.2, . . . 14.n of the driver device 10. Mixed light 5 denote the total light, which is achieved by superposing of the light 51, 52, 53 emitted by each LED 20. During each point in time only one switch 22 of the switching units 14.1 to 14.n is opened to supply energy to the corresponding inductor 32 to increase the current of the corresponding LED 20. As long as only one switch 22 is opened at each point in time, there is a good decoupling between the LEDs 20 of different switching units 14.1, 14.2 . . . 14.n so the current through each LED 20 can be controlled individually. If the LEDs of different switching units emit light of different colors 51, 52, 53, this in turn allows to generate light of a desired color when the LEDs 20 of the different switching units 14.1 to 14.n have different colors. The average light output of the LEDs 20 may be set to a certain level so that the mixed light 5 of all LEDs 20 has then the desired color.

In an alternative embodiment, said LEDs 20 connected to a switching unit 14.1, 14.2, . . . 14.n may be multiple LEDs connected in series (LED string) or parallel (LED-array). The multiple LEDs may emit light of essentially the same color or different colors.

Simultaneously to a color control, individual dimming of each LED or overall dimming of all LEDs from 0% to 100% light output is possible by adjusting the average current though each LED.

The supply voltage 18 is switched on and off depending on the status of the LED switches 22. Only when energy is needed, this means when one switch 22 is opened, the supply voltage is fed to the circuit.

The inventive driver circuit 10 has the advantage that depending on the selection of the components and the selected timing cycle of the switches 22, the circuit can be used to produce the desired relation between average current and ripple current. Driven in an appropriate way, the LEDs 20 are driven with a DC-current with only little ripple so that light output 51, 52, 53 of the LEDs 20 has also very low distortion. Flickering effects to the human eye can be avoided and the sensed light output can be smoothed. Further, no capacitors are required.

1. Driver device for driving and controlling a plurality of light emitting diodes (LEDs), the device comprising:
a control unit, and
at least two switching units coupled in series, each switching unit comprising:
a switch controllable by said control unit, the switch having a first end and a second end,
two connection points for connecting at least one LED of said plurality of LEDs, a first connection point being coupled with the first end of said switch, and
an inductance coupled between the second end of said switch and a second connection point.

2. Driver device of claim 1, further comprising a main switch coupled in series with said switching units and controllable by said control unit.

3. Driver device of claim 2, wherein said control unit is configured to control the main switch for adjusting the average current in said LED.

4. Driver device of claim 1, further comprising a power supply coupled parallel to said series connection of said switching units.

5. Driver device of claim 1, wherein said control unit is configured to control said switches such that only one switch is opened at the same time.

6. Driver device of claim 5, wherein said control unit is configured to control each switch individually for adjusting the average current in said LED.

7. Electroluminescent device comprising
a driver device for driving and controlling a plurality of light emitting diodes (LEDs), the device comprising a control unit, and at least two switching units coupled in series, each switching unit comprising a switch controllable by said control unit and two connection points for connecting at least one LED of said plurality of LEDs, wherein a first connection point is coupled with a first end of said switch, and an inductance coupled between a second end of said switch and a second connection point, and
at least one LED connected to the first and second connection points of the driver device to emit mixed light,
wherein the inductance is configured for facilitating substantially flicker-free operation of said LED.

8. (canceled)

9. Electroluminescent device of claim 7, comprising at least two LEDs emitting light of different colors, each connected to a different switching unit, the control unit being configured to control each switch individually for adjusting a color point of the mixed light.

10-12. (canceled)
